(19) United States
(12) Patent Application Publication
(10) Pub. No.: US 2012/0179989 A1
(43) Pub. Date: Jul. 12, 2012

(54) METHOD FOR DISPLAYING INDOOR ENVIRONMENT CONDITION INFORMATION AND DEVICE THEREOF

(75) Inventors: Haiqing Li, Beijing (CN); Jietao Gao, Beijing (CN)

(73) Assignee: HaiLin Energy Saving Inc., Beijing (CN)

(21) Appl. No.: 12/985,624

(22) Filed: Jan. 6, 2011

(51) Int. Cl. G06F 3/048

(52) U.S. Cl. 715/771

(57) ABSTRACT

It is provided a method for displaying indoor environment condition information including: receiving a request from a user; and displaying, in response to the request, in a first window a graphical user interface which is adapted to present action areas and display areas; wherein the action areas are adapted to set control conditions of the indoor environment condition information in response to a command from the user, and the display areas are adapted to display the indoor environment condition information corresponding to the control conditions. A device for displaying indoor environment condition information is also provided.

### FIELD OF THE INVENTION

The present invention relates to the technical field of graphical user interface, and in particular to information display implemented via high level touch display.

### BACKGROUND OF THE INVENTION

At present, various thermostats have been widely used in many situations, such as private houses, hospitals and home appliances. As is known in the prior art, the thermostats are triggered to work only when the temperature does not reach a predetermined value. Under the control of the thermostats, the temperature can be made substantially constant and electric energy can be saved, which brings significant economical effectiveness to consumers.

Taking the use of a thermostat in a private house as an example, in the use of the thermostat in the prior art, a person may input a predetermined temperature such as 75 degree Fahrenheit (75°) via a plurality of physical buttons on the thermostat, and the predetermined temperature may be stored in the memory of the thermostat. If a detection component detects that the indoor temperature is below 75°, the thermostat will be triggered to initiate a heating process, i.e., it triggers a heater to work to provide heat energy until the indoor temperature reaches 75°. If the a detection component detects that the indoor temperature reaches or exceeds 75°, the thermostat will be triggered to cease the heating process, i.e., it triggers the heater to cease providing heat energy until the indoor temperature is below 75°. In the above process, the indoor temperature can be displayed on the screen of the thermostat. Such a process is repeated, so as to make the indoor temperature substantially constant.

It can be seen from the above that the consumer can set the predetermined temperature only via the plurality of buttons on the thermostat.

In addition, the display of the thermostat in the prior art generally has simple functions, such as display of only temperature, and does not display other information such as humidity.

There is a need to provide a display which can display a large amount of expected information in an intuitive manner and can receive instructions from users conveniently.

### SUMMARY OF THE INVENTION

An embodiment of the present invention provides a machine implemented method for displaying indoor environment condition information, including: receiving a request from a user; and displaying, in response to the request, in a first window a graphical user interface which is adapted to present action areas and display areas; wherein the action areas are adapted to set control conditions of the indoor environment condition information in response to a command from the user, and the display areas are adapted to display the indoor environment condition information corresponding to the control conditions.

Another embodiment of the present invention provides a computer readable storage medium containing executable instructions which when executed by a system cause the system to perform a method for displaying indoor environment condition information, the method comprising: displaying, upon a request from a user, in a first window a graphical user interface which is adapted to present action areas and display areas, wherein the action areas are adapted to set control conditions of the indoor environment condition information in response to a command from the user, and the display areas are adapted to display the indoor environment condition information corresponding to the control conditions.

A further embodiment of the present invention provides a device for displaying indoor environment condition information, including: a receiver adapted to receive a request from a user; and a touch display adapted to display, in response to the request, in a first window a graphical user interface which is adapted to present action areas and display areas; wherein the action areas are adapted to set control conditions of the indoor environment condition information in response to a command from the user, and the display areas are adapted to display the indoor environment condition information corresponding to the control conditions.

By displaying different user interfaces on the touch display according to the present invention, the user can perform convenient operations on the touch display to control the temperature and humidity, thus improving the experience of the user and bringing an intuitive effect. In addition, the temperature and humidity can be controlled and displayed in terms of the different predetermined periods of time in each day of week, and thus accurate control of temperature and humidity can be achieved.

### BRIEF DESCRIPTION OF THE DRAWINGS

The present invention is illustrated by way of example and not limitation in the figures of the accompanying drawings in which like references indicate similar elements.

FIG. 1 is a flowchart of a method for displaying in a first window indoor environment condition information according to an embodiment of the present invention;

FIG. 2 shows an example of a graphical user interface which is implemented by the method according to the embodiment of the present invention as illustrated in FIG. 1;

FIG. 3 shows an example of a graphical user interface which displays in a second window a plurality of sub-action areas of the option of SYSTEM in response to a touch selection from the user;

FIG. 4 shows an example of a graphical user interface which displays in a third window a plurality of sub-action areas of the option of FAN in response to a touch selection from the user;

FIG. 5 shows an example of a graphical user interface which displays in a fourth window a plurality of sub-action areas of the option of PROG in response to a touch selection from the user;

FIG. 6a shows an example of a graphical user interface which displays in a fifth window a plurality of sub-action areas of the option of MENU in response to a touch selection from the user;

FIG. 6b shows an example of a graphical user interface which displays in a sixth window a plurality of sub-action areas of the option of MENU subsequent to FIG. 6a;

FIG. 6c shows an example of a graphical user interface which displays in a seventh window a plurality of sub-action areas of the option of MENU subsequent to FIG. 6b;

FIG. 7 illustrates an example of a user interface of the option of VIDEO FREQUENCY as illustrated in FIG. 6b;

FIG. 8 shows another example of a graphical user interface which is implemented by the method according to the embodiment of the present invention as illustrated in FIG. 1;

FIG. 9 illustrates an example of a user interface of HOLIDAY1 as described in FIG. 8;

FIG. 10 is a flowchart of a method for displaying in a first window indoor environment condition information according to another embodiment of the present invention;

FIG. 11 is a structural diagram of a device for displaying window indoor environment condition information according to an embodiment of the present invention; and

FIG. 12 is a structural diagram of a device for displaying window indoor environment condition information according to another embodiment of the present invention.

### DETAILED DESCRIPTION OF THE INVENTION

The forgoing and other objects, features and advantages of the present invention will be apparent from the following more particular description of a preferred embodiment of the present invention, as illustrated in the accompanying drawings wherein like reference numbers represent like parts of the present invention.

The present invention is preferably realized as a graphical user interface (GUI) or dialog object integrated into a function or application program on a computer or computer-based system. The computer-based system is preferably provided with an operating system which provides common GUI functions, such as pointer location and movement detection, event handling based on areas on the touch display in which the pointer is located, and event handling of pointer selection such as mouse clicks. As such, the present invention can be realized on personal computers, palm-top computers and personal digital assistants, as well as other devices incorporating graphical user displays such as cell phones and wireless web browsers.

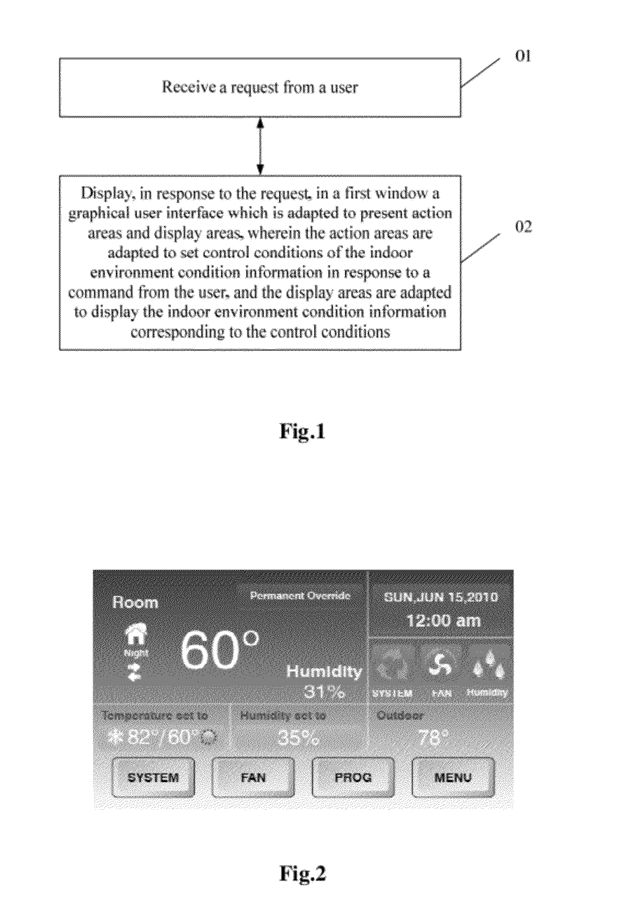

FIG. 1 is a flowchart of a method for displaying in a first window indoor environment condition information according to an embodiment of the present invention.

In this embodiment, a touch display is utilized to display the indoor environment condition information. As illustrated in FIG. 1, the method includes the following steps:

In step 01, the touch display receives a request from a user.

Specifically, the user may transmit the request to the touch display by supplying power to the touch display or by starting the touch display.

In step 02, in response to the request from the user, the touch display provides a first window in which a graphical user interface is displayed, which is adapted to present a plurality of action areas and a plurality of display areas. After the touch display is powered on or started, the touch display displays the graphical user interface on which there may be provided the plurality of action areas and the plurality of display areas. The action areas and display areas provide an initial graphical user interface (also referred to as home page) on which texts and icons are presented. If the user needs to change the current indoor environment condition information, the user may transmit a command by touching on one of the action areas to the touch display, to set control conditions of the indoor environment condition information. Then, in response to the control conditions, the touch display triggers a corresponding action, such as a heating process, and thus a corresponding one of the display areas changes its initial presentation to another one indicating the heating process. In this case, the touch display can provide an intuitive interface to the user.

FIG. 2 shows an example of a graphical user interface which is implemented by the method according to the embodiment of the present invention as illustrated in FIG. 1. In FIG. 2, the temperature is displayed in the unit of degree Fahrenheit.

As illustrated in FIG. 2, the indoor environment condition information may include at least one of: indoor temperature (60°), humidity (31%), and outdoor temperature (78°). In an alternative embodiment, the indoor environment condition information may include only indoor temperature and humidity. The appearance of the graphical user interface displays a gradually-variable blue color, which may bring a clear-headed emotion to the user.

Referring to FIG. 2, the control conditions of the indoor environment condition information are classified into four options: SYSTEM, FAN, PROG, and MENU. The four options are identified on the corresponding action areas. The action areas are configured to display as virtual buttons for clarity and operability. The option of SYSTEM refers to system control information. The option of FAN refers to fan control information. The option of PROG refers to program information. The option of MENU refers to display setting information.

The display areas may display values and/or icons in response to the control conditions of the indoor environment condition information. Again referring to FIG. 2, the display areas display the date of year (JUN 15, 2010), the day of week (SUN), the current time (12:00 am), the temperature set to (the heat temperature set to/the cool temperature set to =82°/60°), the humidity set to (35%), the outdoor temperature (78°), the indoor temperature (60°), the indoor humidity (31%) and icons corresponding to the control conditions of the indoor environment condition information. In an alternative embodiment, the display areas may further display a reference humidity range including dry, comfortable and wet, so that the user may perform settings to obtain an appropriate humidity according to the reference humidity range.

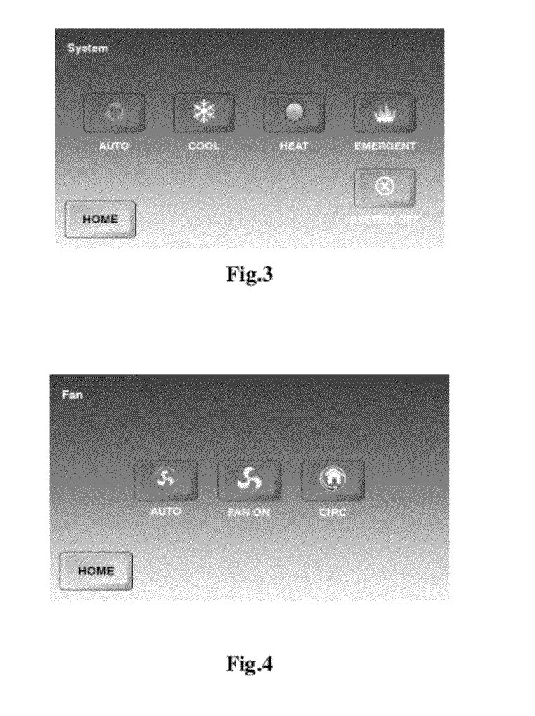

FIG. 3 shows an example of a graphical user interface which displays in a second window a plurality of sub-action areas of the option of SYSTEM in response to a touch selection from the user.

Specifically, if the user selects to touch the option of SYSTEM as illustrated in FIG. 2, the touch display provides the second window in which the plurality of sub-action areas of the option “SYSTEM” are displayed. As illustrated in FIG. 3, the plurality of sub-action areas includes five options: AUTO, COOL, HEAT, EMERGENT, and SYSTEM OFF. Five intuitive icons corresponding to the options are identified on the corresponding sub-action areas. The sub-action areas are configured to display as virtual buttons for clarity and operability. Specifically, the option of AUTO refers to an automatic mode in which the touch display operates. The option of COOL refers to a cool operation mode in which the touch display operates. The option of HEAT refers to a heat operation mode in which the touch display operates. The option of EMERGENT refers to an emergence operation mode in which the touch display operates. The option of SYSTEM OFF refers to turning off of the “SYSTEM”.

If the user selects to touch one of the above sub-action areas such as the option of HEAT, the touch display is triggered to initiate a heating process, i.e., the touch display triggers a heater to provide heat energy. At this time, if the user operates to turn to the user interface of FIG. 2, the icon of the option of SYSTEM changes into an icon indicating the heating process correspondingly.

FIG. 4 shows an example of a graphical user interface which displays in a third window a plurality of sub-action areas of the option of FAN in response to a touch selection from the user.

Specifically, if the user selects to touch the option of FAN as illustrated in FIG. 2, the touch display provides the third window in which the plurality of sub-action areas of the option of FAN are displayed. As illustrated in FIG. 4, the plurality of sub-action areas includes three options: AUTO, FAN ON, and CIRC. Three intuitive icons corresponding to the options are identified on the corresponding sub-action areas. The sub-action areas are configured to display as virtual buttons for clarity and operability. Specifically, the option of AUTO refers to an automatic mode in which a fan connected to the touch display operates. The option of FAN ON refers to that the fan is triggered to operate immediately. The option of CIRC refers to that the fan is triggered to operate in a ventilation mode.

For example, if the user selects to touch one of the above sub-action areas such as the option of CIRC, the touch display is triggered to initiate a circulation process, i.e., the touch display triggers the fan to perform ventilation. At this time, if the user operates to turn to the user interface of FIG. 2, the icon of the “FAN” changes into an icon indicating the circulation process.

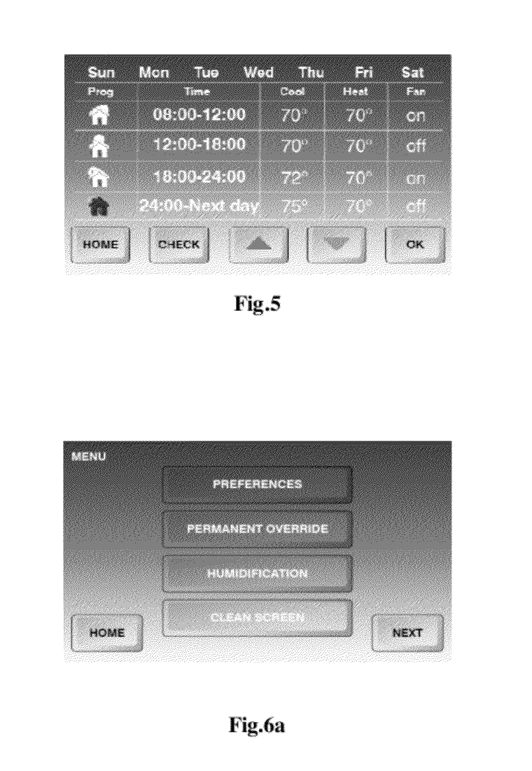

FIG. 5 shows an example of a graphical user interface which displays in a fourth window a plurality of sub-action areas of the option of PROG in response to a touch selection from the user.

Specifically, if the user selects to touch the option of PROG as illustrated in FIG. 2, the touch display provides the fourth window in which the plurality of sub-action areas of the option of PROG are displayed. As illustrated in FIG. 5, the plurality of sub-action areas includes a plurality of options: seven days of week (Sun, Mon, Tue, Wed, Thu, Fri, Sat), predetermined periods of time in each day of week (which are identified as “Time”), the cool temperature set to (which is identified as “Cool”), the heat temperature set to (which is identified as “Heat”), and the fan status (which is identified as “Fan”). In addition, the predetermined periods of time in each day of week are identified in the fourth window by not only texts but also corresponding icons, which may bring an intuition to the user. In addition, the user interface in the option of PROG as illustrated in FIG. 5 further includes sub-action areas which are identified as HOME', CHECK, OK, an up arrow area, and a down arrow area. The sub-action area of CHECK refers to selecting to view the content of the program from Sunday to Monday which is set by the user.

The graphical user interface displays the indoor environment condition information in terms of predetermined periods of time in each day of week. The division of the predetermined periods of time in a certain day of week may be the same or different from another day. In a traditional thermostat, the predetermined periods of time from Monday to Friday are the same as each other, which are different from those of weekend (Saturday and Sunday), i.e., 5+2 mode. It should be noted that the length of day of week here may not be strictly defined to be natural 24 hours from 00:00 to 24:00, but may be defined to be less 24 hours or more than 24 hours, e.g., from 24:00-07:00, if only a majority of the day of week falls in a range of natural hours from 00:00-24:00 of the day of week and each week includes 7*24 hours. For example, the period of time from 24:00 Sunday to 07:00 Tuesday is defined as Monday. For example, a certain day of week can be divided, as illustrated in FIG. 5, into four predetermined periods of time: 08:00-12:00, 12:00-18:00, 18:00-24:00, 24:00-Next day. Here, the “Next day” may be, for example, 06:00 on the next day or 07:00 on the next day.

The user may touch “CHECK” to select any one of the seven days of week to view the corresponding content of the PROG.

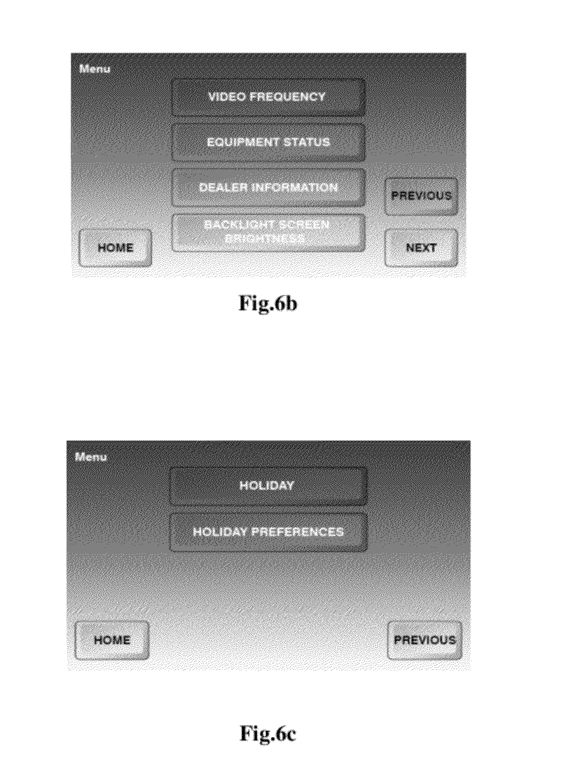

FIG. 6a shows an example of a graphical user interface which displays in a fifth window a plurality of sub-action areas of the option of MENU in response to a touch selection from the user.

Specifically, if the user selects to touch the option of MENU as illustrated in FIG. 2, the touch display provides the fifth window in which the plurality of sub-action areas of the option of MENU are displayed. As illustrated in FIG. 6a, the plurality of sub-action areas includes four options in this window (i.e., the first page): PREFERENCES, PERMANENT OVERRIDE, HUMIDIFICATION, CLEAN SCREEN. Specifically, the option of PREFERENCES refers to the preferences of the user. The user may turn to the next page by touching the option of NEXT.

As illustrated in FIG. 6b, which shows an example of a graphical user interface which displays in a sixth window a plurality of sub-action areas of the option of MENU subsequent to FIG. 6a, the touch display provides the sixth window in which a plurality of sub-action areas of the option of MENU are displayed. The plurality of sub-action areas includes four options in this window: VIDEO FREQUENCY, EQUIPMENT STATUS, DEALER INFORMATION, and BACKLIGHT SCREEN BRIGHTNESS. The user may turn to the previous page as illustrated in FIG. 6a by touching the option of PREVIOUS. Also, the user may turn to the next page by touching the option of NEXT.

As illustrated in FIG. 6c, which shows an example of a graphical user interface which displays in a seventh window a plurality of sub-action areas of the option of MENU subsequent to FIG. 6b, the touch display provides the seventh window in which a plurality of sub-action areas of the option of MENU are displayed. The plurality of sub-action areas includes two options in this window: HOLIDAY and HOLIDAY PREFERENCES. The user may turn to the previous page as illustrated in FIG. 6b by touching the option of PREVIOUS.

Of course, all of the sub-action areas of the option of MENU can be displayed in one window (one page) if the screen of the touch display is large enough.

After the user has set the information on SYSTEM, FAN, PROG and MENU, a memory of the touch display stores the information. For example, if the outdoor temperature is below the cool temperature set to, the touch display drives the heater to operate. Similarly, if the outdoor temperature is above the heat temperature set to, the touch display initiates the heating process.

In addition, the information that the user has set can be protected in the memory of the touch display if the power supply of the touch display is interrupted.

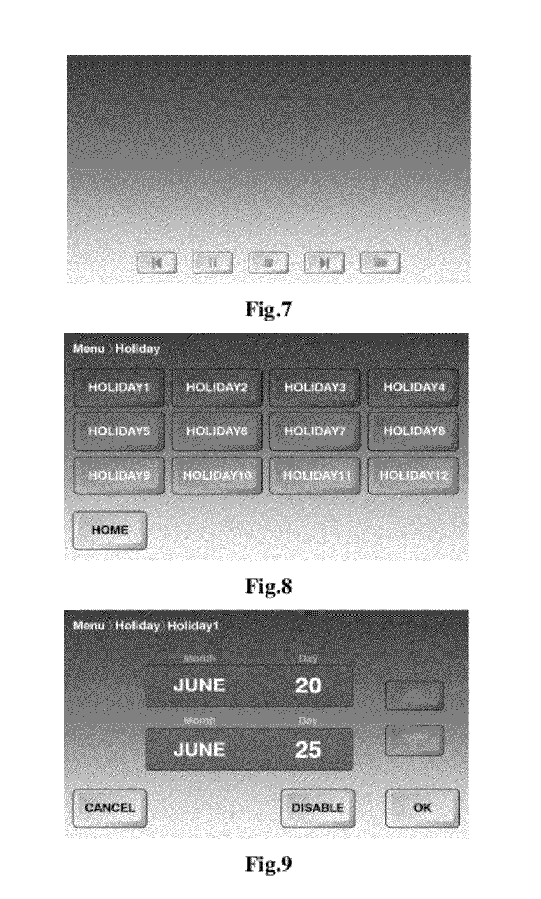

FIG. 7 illustrates an example of a user interface of the option of VIDEO FREQUENCY as illustrated in FIG. 6b. If the user needs help on the touch display, he may touch the VIDEO FREQUENCY to acquire relevant video guidance information.

It should be noted that the mode in which the touch display operates as illustrated in FIG. 2 is a “Run as schedule” mode. Besides this mode, the touch display may operate in other modes including: Permanent Override and Holiday. The touch display can switch from one mode to another circularly, and the user interface as illustrated in FIG. 2 displays the mode after switching.

The mode of Holiday is configured for the user's outdoor traveling. If the touch display operates in the mode of Run as schedule and a predetermined period of time that the user has set arrives, the touch display goes into the mode of Holiday automatically. After the predetermined period of time that the user expires, the touch display goes back to the mode of Run as schedule automatically.

The mode of Permanent Override has a highest priority among the modes. In this case, the touch display can not automatically go into another mode from the mode of Permanent Override even if a predetermined period of time in the mode of Holiday that the user has set for example arrives, unless the user manually modify the mode of Permanent Override.

In the mode of Run as schedule, the touch display may go into a mode of Temporary if the user touches the option of SYSTEM or FAN to set corresponding information. In the mode of Temporary, the user can temporarily set the temperature and humidity under the condition that the information has been set in the mode of Run as schedule.

FIG. 8 shows another example of a graphical user interface which is implemented by the method according to the embodiment of the present invention as illustrated in FIG. 1. As illustrated in FIG. 8, the touch display operates in the mode of Holiday and the user interface presents twelve options from HOLIDAY1 to HOLIDAY12. The user can set the date of holiday and indoor temperature.

FIG. 9 illustrates an example of a user interface of HOLIDAY1 as described in FIG. 8.

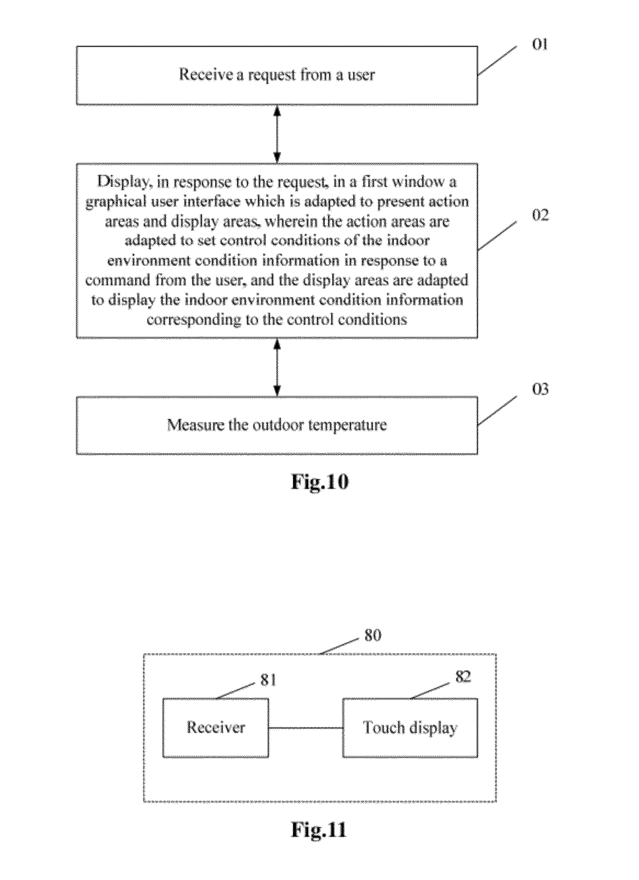

FIG. 10 is a flowchart of a method for displaying in a first window indoor environment condition information according to another embodiment of the present invention.

Compared with FIG. 1, the method according to the embodiment in FIG. 10 further includes a step of measuring the outdoor temperature. The measurement can be performed by a detection component, which transmits periodically detected outdoor temperature to the touch display. The processes in FIG. 10 as the same as those in FIG. 1 are not described in detail here.

FIG. 11 is a structural diagram of a device for displaying indoor environment condition information according to an embodiment of the present invention.

As illustrated in FIG. 11, the device (80) for displaying indoor environment condition information according to an embodiment of the present invention includes: a receiver (81) adapted to receive a request from a user, and a touch display (82) adapted to display, in response to the request, in a first window a graphical user interface which is adapted to present action areas and display areas; where the action areas are adapted to set control conditions of the indoor environment condition information in response to a command from the user, and the display areas are adapted to display the indoor environment condition information corresponding to the control conditions.

Operations of respective components of the device (80) as illustrated in FIG. 11 can be made a reference to the flow of the method as illustrated in FIG. 1, which is not repeated here.

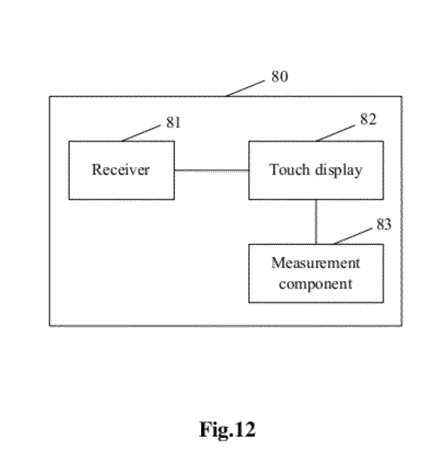

FIG. 12 is a structural diagram of a device for displaying window indoor environment condition information according to another embodiment of the present invention.

Compared with FIG. 11, the device (80) according to the embodiment in FIG. 12 further includes a measurement component (83), which is adapted to measure the outdoor temperature and transmit the outdoor temperature to the touch display. In practice, the measurement component (83) may transmit the outdoor temperature to the touch display.

Operations of the device (80) as illustrated in FIG. 12 can be made a reference to the flow of the method as illustrated in FIG. 2, which is not repeated here.

All the action areas and sub-action areas are configured to display as virtual buttons for clarity and operability.

In the above drawings, “HOME” refers to going back to the home page, i.e., the user interface as illustrated in FIG. 2.

As can be appreciated by an ordinary skilled in the art, the method of the present invention can be implemented in hardware or software. Another embodiment of the present invention provides a computer readable storage medium containing executable instructions which when executed by a system cause the system to perform a method for displaying indoor environment condition information, the method comprising: displaying, upon a request from a user, in a first window a graphical user interface which is adapted to present action areas and display areas, wherein the action areas are adapted to set control conditions of the indoor environment condition information in response to a command from the user, and the display areas are adapted to display the indoor environment condition information corresponding to the control conditions.

By displaying different user interfaces on the touch display according to the present invention, the user can perform convenient operations on the touch display to control the temperature and humidity, thus improving the experience of the user and bringing an intuitive effect. In addition, the temperature and humidity can be controlled and displayed in terms of the different predetermined periods of time in each day of week, and thus accurate control of temperature and humidity can be achieved.

The technical solutions in the embodiments of the present invention will be described clearly and completely below with reference to the attached drawings. Evidently, the described embodiments are merely a part but not all of the embodiments of the present invention. Based on the embodiments of the present invention here, any other embodiments which will occur to those ordinarily skilled in the art without any inventive effort shall fall into the claimed scope of the present invention.

The foregoing descriptions are merely illustrative of the preferred embodiments of the present invention, and it shall be pointed out that those ordinarily skilled in the art can further make several adaptations and variations without departing from the spirit of the present invention and that these adaptations and variations shall also be construed as falling into the claimed scope of the present invention.

1. A machine implemented method for displaying indoor environment condition information, comprising:
receiving a request from a user; and
displaying, in response to the request, in a first window a graphical user interface which is adapted to present action areas and display areas;
wherein the action areas are adapted to set control conditions of the indoor environment condition information in response to a command from the user, and the display areas are adapted to display the indoor environment condition information corresponding to the control conditions.

2. The method according to claim 1, wherein the control conditions of the indoor environment condition information comprise the following operation modes: Run as schedule, Permanent Override and Holiday, and the method switches between the options.

3. The method according to claim 2, wherein in the operation mode of Run as schedule, each day of week is divided into a plurality of predetermined periods of time, the graphical user interface displays the indoor environment condition information in terms of the predetermined periods of time in each day of week, and the predetermined periods of time in each day of week are set via a touch display having the graphical user interface.

4. The method according to claim 3, wherein the length of the each day of week is defined to be less 24 hours or more than 24 hours, a majority of the each day of week falls in a range of natural hours from 00:00-24:00 of the each day of week, and each week includes 7 multiplied by 24 hours.

5. The method according to claim 4, wherein the method switches between the operation mode of Run as schedule and the operation mode of Holiday switch in response to the predetermined periods of time, and switches from and to the operation mode of Permanent Override in response to an instruction from the user.

6. The method according to claim 3, wherein the indoor environment condition information comprises at least one of temperature and humidity, and the display areas are further adapted to display an outdoor temperature, and current date and time.

7. The method according to claim 3, wherein the control conditions of the indoor environment condition information further comprise at least one of the following options: SYSTEM, FAN, PROG and MENU.

8. The method according to claim 7, wherein the method goes into an operation mode of Temporary by the user selecting SYSTEM or FAN in the operation mode of Run as schedule.

9. The method according to claim 7, further comprising: displaying in a second window a plurality of sub-action areas indicating auto, cool, heat, emergent and system off modes in which the touch display operates in the option of SYSTEM in response to a touch selection from the user.

10. The method according to claim 7, further comprising: displaying in a third window a plurality of sub-action areas indicating auto, on and ventilation modes in which the fan operates in the option of FAN in response to a touch selection from the user.

11. The method according to claim 7, further comprising: displaying in a fourth window a plurality of sub-action areas presenting each day of week, the predetermined periods of time, a cool temperature set to, and a heat temperature set to and a fan status in the option of PROG in response to a touch selection from the user.

12. The method according to claim 7, further comprising: displaying in one or more windows a plurality of sub-action areas indicating preferences, permanent override, humidification, clean screen, video frequency, equipment status, dealer information, backlight screen brightness, holiday and holiday preferences in the option of MENU in response to a touch selection from the user.

13. The method according to claim 1, further comprising the step of measuring the outdoor temperature.

14. A computer readable storage medium containing executable instructions which when executed by a system cause the system to perform a method for displaying indoor environment condition information, the method comprising: displaying, upon a request from a user, in a first window a graphical user interface which is adapted to present action areas and display areas, wherein the action areas are adapted to set control conditions of the indoor environment condition information in response to a command from the user, and the display areas are adapted to display the indoor environment condition information corresponding to the control conditions.

15. The computer readable storage medium according to claim 14, wherein the indoor environment condition information comprises at least one of temperature and humidity, and the display areas are further adapted to display an outdoor temperature and current date and time.

16. A device for displaying indoor environment condition information, comprising:
a receiver adapted to receive a request from a user; and
a touch display adapted to display, in response to the request, in a first window a graphical user interface which is adapted to present action areas and display areas;
wherein the action areas are adapted to set control conditions of the indoor environment condition information in response to a command from the user, and the display areas are adapted to display the indoor environment condition information corresponding to the control conditions.

17. The device according to claim 16, wherein the control conditions of the indoor environment condition information comprise the following operation modes: Run as schedule, Permanent Override and Holiday, and the method switches between the operation modes.

18. The device according to claim 17, wherein in the mode of Run as schedule, each day of week is divided into a plurality of predetermined periods of time, the graphical user interface displays the indoor environment condition information in terms of the predetermined periods of time in each day of week, and the predetermined periods of time in each day of week are set via a touch display having the graphical user interface.

19. The device according to claim 18, wherein the length of the each day of week is defined to be less 24 hours or more than 24 hours, and a majority of the each day of week falls in a range of natural hours from 00:00-24:00 of the each day of week, and each week includes 7 multiplied by 24 hours.

20. The device according to claim 19, wherein the touch display switches between the operation mode of Run as schedule and the operation mode of Holiday switch in response to the predetermined periods of time, and switches from and to the operation mode of Permanent Override in response to an instruction from the user.

21. The device according to claim 18, wherein the indoor environment condition information comprises at least one of temperature and humidity, and the display areas are further adapted to display an outdoor temperature, and current date and time.

22. The device according to claim 18, wherein the control conditions of the indoor environment condition information further comprise at least one of the following options: SYSTEM, FAN, PROG and MENU.

23. The device according to claim 22, further comprising: displaying in a second window a plurality of sub-action areas indicating auto, cool, heat, emergent and system off modes in which the touch display operates in the option of SYSTEM in response to a touch selection from the user.

24. The device according to claim 22, further comprising: displaying in a third window a plurality of sub-action areas indicating auto, on and ventilation modes in which the fan operates in the option of FAN in response to a touch selection from the user.

25. The device according to claim 22, further comprising: displaying in a fourth window a plurality of sub-action areas presenting each day of week, the predetermined periods of time, a cool temperature set to, and a heat temperature set to and a fan status in the option of PROG in response to a touch selection from the user.

26. The device according to claim 22, further comprising: displaying in one or more windows a plurality of sub-action areas indicating preferences, permanent override, humidification, clean screen, video frequency, equipment status, dealer information, backlight screen brightness, holiday and holiday preferences in the option of MENU in response to a touch selection from the user.

27. The device according to claim 16, further comprising a measurement component adapted to measure the outdoor temperature and transmit the outdoor temperature to the touch display.
